(19) United States
(12) Patent Application Publication
(10) Pub. No.: US 2017/0083399 A1
(43) Pub. Date: Mar. 23, 2017

(54) SYSTEMS AND METHODS FOR ASSISTING USER IN SOFTWARE APPLICATION CRASHES

(71) Applicant: Limited Liability Company Mail.Ru, Moscow (RU)

(72) Inventor: Alexander Vyacheslavovich SMIRNOV, Odintsovo (RU)

(21) Appl. No.: 15/190,204

(22) Filed: Jun. 23, 2016

Related U.S. Application Data
(63) Continuation of application No. PCT/RU2013/001204, filed on Dec. 30, 2013.

(51) Int. Cl. G06F 11/07

(52) U.S. Cl. CPC G06F 11/0793; G06F 11/0709; G06F 11/0751; G06F 11/0787; G06F 11/079

(57) ABSTRACT

A method for handling a crash of an application, the computer-implemented method being performed in connection with a distributed computer system comprising a client system directly accessible by a user and a server system, the client system including a CPU and a memory, the method involving: upon occurrence of the crash of the application on the client system, locally storing an application crash information; and upon a subsequent launch of the application: suspending execution of at least a portion of a code of the application; retrieving from the memory the stored application crash information; generating a signature of the crash of the application based on the retrieved application crash information; sending the generated signature of the crash of the application to the server system; receiving remedial action information from the server system; and performing a remedial action in connection with the application based on the received remedial action information.

### BACKGROUND OF THE INVENTION

Field of the Invention

The disclosed embodiments relate in general to the field of software application technology and in particular to systems and methods for using information associated with a software application crash to promptly assist the user in dealing with the application crash.

Description of the Related Art

Software applications executing on computer systems, such as desktops or mobile devices, may crash for various reasons. The term “application crash” is usually used to refer to an abnormal termination of the software application processes by the operating system. Software application crashes may happen due to a variety of reasons, but they mainly result from the application performing an action prohibited by the operating system, which may take place due to software bugs, memory content corruption due to earlier errors, incorrect memory addressing, as well as similar causes.

Conventional techniques for handling of software application crashes usually include gathering of various information related to the crash, such as state of the crashed application as well as the values of processor registers immediately before the cash and prompting the user to indicate whether he or she desires to send the crash report to the developer of the software application involved in the crash. If the user so indicates, the crash report is sent via a network to the developer of the software application, who analyses the received crash reports and attempts to fix the issues causing the application crashes in the next release of the application.

As would be appreciated by persons of ordinary skill in the art, the next release of the application may take considerable time. For example, in Apple's App Store, release of a new version of an application correcting earlier bugs may take up to two weeks. During this time, the user is left helpless with the persistently crashing software application, which unquestionably compromises user experience.

Therefore, new and improved systems and methods for handling software application crashes are needed that would provide prompt assistance to the user in dealing with the application crash.

### SUMMARY OF THE INVENTION

The inventive methodology is directed to methods and systems that substantially obviate one or more of the above and other problems associated with conventional techniques for handling software application crashes.

In accordance with one aspect of the embodiments described herein, there is provided a computer-implemented method for handling a crash of an application, the computer-implemented method being performed in connection with a distributed computer system comprising a client computer system directly accessible by a user and a server computer system, the client computer system comprising a central processing unit and a memory, the computer-implemented method involving: upon occurrence of the crash of the application on the client computer system, locally storing an application crash information in the memory; and upon a subsequent launch of the application: suspending execution of at least a portion of a code of the application; retrieving from the memory the stored application crash information; generating, using the central processing unit, a signature of the crash of the application based on the retrieved application crash information; sending the generated signature of the crash of the application to the server computer system; receiving remedial action information from the server computer system; and performing a remedial action in connection with the application based on the received remedial action information.

In one or more embodiments, a normal launch of the application is subsequently resumed.

In one or more embodiments, the application crash information is stored in a library.

In one or more embodiments, the application crash information includes a stack trace associated with the crash of the application.

In one or more embodiments, the stack trace includes multiple relative addresses of functions executed immediately before crash and the signature of the crash of the application is generated by hashing a concatenation of these relative addresses.

In one or more embodiments, the received remedial action information includes a message for displaying to the user and performing the remedial action involves displaying the message to the user.

In one or more embodiments, the received remedial action information further includes an instruction to suspend the execution of the application and performing the remedial action further involves suspending the execution of the application.

In one or more embodiments, the received remedial action information includes an instruction to change configuration parameters of the application and performing the remedial action involves changing the configuration parameters of the application.

In one or more embodiments, the received remedial action information includes an instruction to change access permissions of the application and performing the remedial action involves changing the access permissions of the application.

In accordance with another aspect of the embodiments described herein, there is provided a non-transitory computer-readable medium embodying a set of computer-readable instructions, which, when executed in connection with a distributed computer system comprising a client computer system directly accessible by a user and a server computer system, the client computer system comprising a central processing unit and a memory, cause the client computer system to perform a computer-implemented method for handling a crash of an application, the computer-implemented method involving: upon occurrence of the crash of the application on the client computer system, locally storing an application crash information in the memory; and upon a subsequent launch of the application: suspending execution of at least a portion of a code of the application; retrieving from the memory the stored application crash information; generating, using the central processing unit, a signature of the crash of the application based on the retrieved application crash information; sending the generated signature of the crash of the application to the server computer system; receiving remedial action information from the server computer system; and performing a remedial action in connection with the application based on the received remedial action information.

In one or more embodiments, a normal launch of the application is subsequently resumed.

In one or more embodiments, the application crash information is stored in a library.

In one or more embodiments, the application crash information includes a stack trace associated with the crash of the application.

In one or more embodiments, the stack trace includes multiple relative addresses of functions executed immediately before crash and the signature of the crash of the application is generated by hashing a concatenation of these relative addresses.

In one or more embodiments, the received remedial action information includes a message for displaying to the user and performing the remedial action involves displaying the message to the user.

In one or more embodiments, the received remedial action information further includes an instruction to suspend the execution of the application and performing the remedial action further involves suspending the execution of the application.

In one or more embodiments, the received remedial action information includes an instruction to change configuration parameters of the application and performing the remedial action involves changing the configuration parameters of the application.

In one or more embodiments, the received remedial action information includes an instruction to change access permissions of the application and performing the remedial action involves changing the access permissions of the application.

In accordance with yet another aspect of the embodiments described herein, there is provided a client computer system directly accessible by a user, the client computer system comprising a central processing unit and a memory storing a set of instructions executable by the central processing unit, the set of instructions comprising instructions for: upon occurrence of a crash of an application on the client computer system, locally storing an application crash information in the memory; and upon a subsequent launch of the application: suspending execution of at least a portion of a code of the application; retrieving from the memory the stored application crash information; generating, using the central processing unit, a signature of the crash of the application based on the retrieved application crash information; sending the generated signature of the crash of the application to a server computer system; receiving remedial action information from the server computer system; and performing a remedial action in connection with the application based on the received remedial action information.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates a logical diagram of an exemplary embodiment of a distributed computerized system for assisting the user in remedying the software application crash.

FIG. 2 provides a diagram illustrating command and data flows in an exemplary embodiment of a distributed computerized system for assisting the user in remedying the software application crash.

FIG. 3 illustrates an exemplary operating sequence of an embodiment of a distributed computerized system 100 for assisting the user in remedying the software application crash.

FIG. 4 illustrates an exemplary user interface of a distributed computerized system for assisting the user in remedying the software application crash.

FIG. 5 is a block diagram that illustrates an exemplary embodiment of a client portion of the distributed computerized system for assisting the user in remedying the software application crash.

FIG. 6 is a block diagram that illustrates an exemplary embodiment of a server portion of the distributed computerized system for assisting the user in remedying the software application crash.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one or more embodiments described herein, there are provided systems and methods for handling software application crashes that provide prompt assistance to the user in dealing with the crash. Specifically, the information associated with a software application crash that has taken place on a client computer system accessible by the user is utilized by the inventive systems and methods in order to assist the user in remedying the crash. In one or more embodiments, the software executing on the client computer system gathers the information associated with the software application crash, packages it and sends it via a network to a remote server system. The inventive software executing on the server system, in turn, analyses the received information and provides a response to the client computer system, which is used by the client computer system to assist the user with handling the software application crash. In one or more embodiments, the remedial action information received from the server may be used to automatically remedy the error that led to the prior software application crash or to display a certain predetermined message to the user informing the user how to properly remedy the application crash.

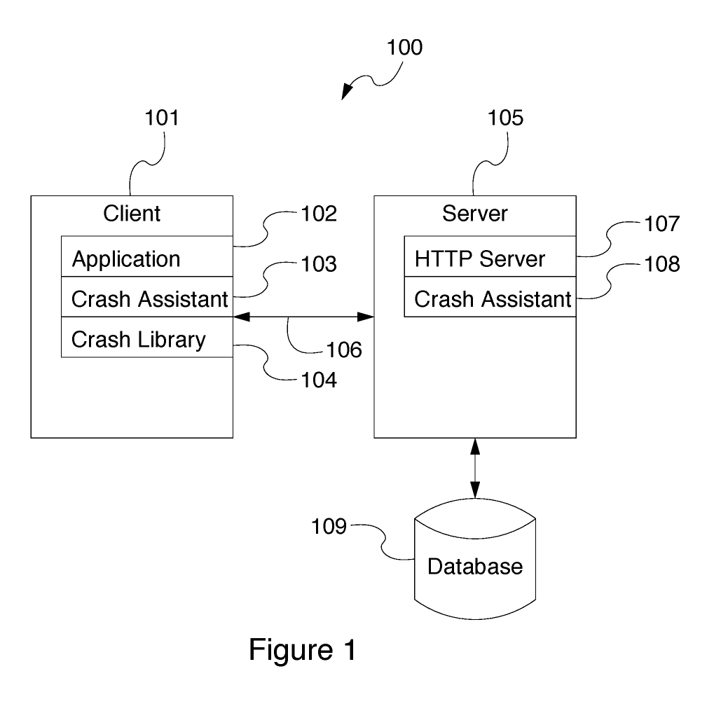

FIG. 1 illustrates a logical diagram of an exemplary embodiment of a distributed computerized system 100 for assisting the user in properly handling the software application crash. In the embodiment shown in FIG. 1, a client computer system 101 executes a client application 102. A client side crash assistant application 103 and a crash handling library 104 are also deployed on the client computer system 101. In various embodiments, the client application 102 may be any software application, such as a mobile application, that is configured to use the client side crash assistant application 103 for purposes of handling application crashes. The client side crash assistant application 103 is configured to use the information from the crash handling library 104 as well as a remedial action information received from a server computer system 105 via a network 106 to handle specific crashes of the application 102 in accordance with techniques described in detail below. In one or more embodiments, the client side crash assistant application 103, in response to a crash of the application 102, presents the user of the client computer system 101 with information related to a particular crash of the application 102. The crash handling library 104 is configured to collect information on application crashes and provide the collected information to the client side crash assistant application 103. In one or more embodiments, upon occurrence of an application crash, the crash handling library 104 is configured to extract a stack trace associated with the application crash event using its internal algorithms and store the extracted stack trace information in the memory for later retrieval. In one or more embodiments, the stored stack trace includes multiple relative addresses of functions executed immediately before crash. The aforesaid stack trace is well-known to persons of ordinary skill in the art and carries information on where the fatal error resulting in the application crash has occurred enabling post-mortem debugging of the crashed application.

The server computer system 105 executes a server application, such as an HTTP server 107, for communicating with the client application via the network 106 using a network communication protocol, such as HTTP. Additionally executed by the server 105 is a server side crash assistant application 108, which is configured to work with the client side crash assistant application 103. Specifically, the server side crash assistant application 108 is configured to receive the stack trace related to the application crash from the client side crash assistant application 103 (or the signature of the respective stack trace), determine the appropriate remedial action based on the received stack trace (or its signature) and forward the remedial action information to the client side crash assistant application 103. To this end, the server side crash assistant application 108 operates in conjunction with a database 109 storing plurality of crash signatures and the associated remedial action information. Specifically, in one or more embodiments, the remedial action information sent to the client side crash assistant application 103 by the server side crash assistant application 108 may include one or more instructions on how to remedy the application crash. In one embodiment, these instructions may comprise a message to be displayed to the user on handing the crash. In another, alternative embodiment, the sent instructions may include a configuration change information or an access permission change information.

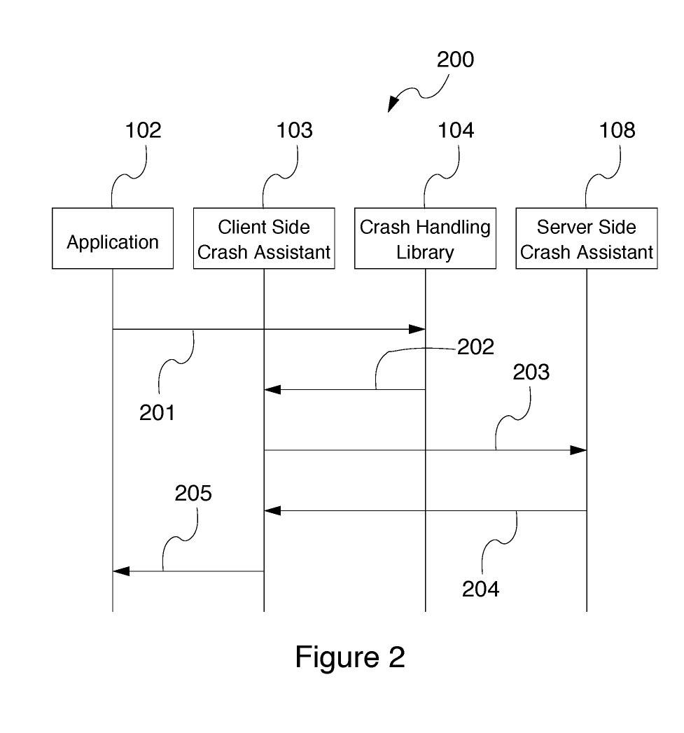

FIG. 2 provides a diagram 200 illustrating command and data flows in an exemplary embodiment of a distributed computerized system 100 for assisting the user in properly handling the software application crash. Initially, upon the occurrence of a crash of the application 102, the crash handling library 104 extracts and stores stack trace 201 related to the crash of the application 102. Upon the next launch of the application 102, the client side crash assistant application 103 queries the crash handling library 104 for evidence of a prior crash of the application 102. In response, the crash handling library 104 provides the client side crash assistant application 103 with the details 202 (stack trace) of last occurred crash. Based on the received stack trace, the client side crash assistant application 103 creates a crash signature using, for example, relative addresses from the stack trace.

Subsequently, the client side crash assistant application 103 sends the created crash signature, the application version and the mobile operating system version (collectively, 203) to the server side crash assistant application 108. Upon receiving this information from the client side crash assistant application 103, the server side crash assistant application 108 determines the appropriate remedial action using the received crash signature and the application version. In one or more embodiments, the remedial action may include one or more of the following: a message to be displayed to the user, a change in the application or system configuration parameters, a change of access permissions and/or an application launch strategy. The determined remedial action information 204 is then sent to the client side crash assistant application 103. Finally, based on the remedial action information received from the server side crash assistant application 108, the client side crash assistant application 103 sends one or more remedial commands 205 to the application 102. Exemplary remedial commands may include, without limitation, a command to pause the application launch process for a predetermined amount of time (e.g. 20 seconds) and display a predetermined message to user, to simply display the message to the user without pausing the launch or to change certain configuration parameters or access permissions of the application prior to the next application launch. It should be noted that the invention is not limited to the provided examples of the remedial commands and many other types of remedial commands may be used without departing from the scope and spirit of the invention.

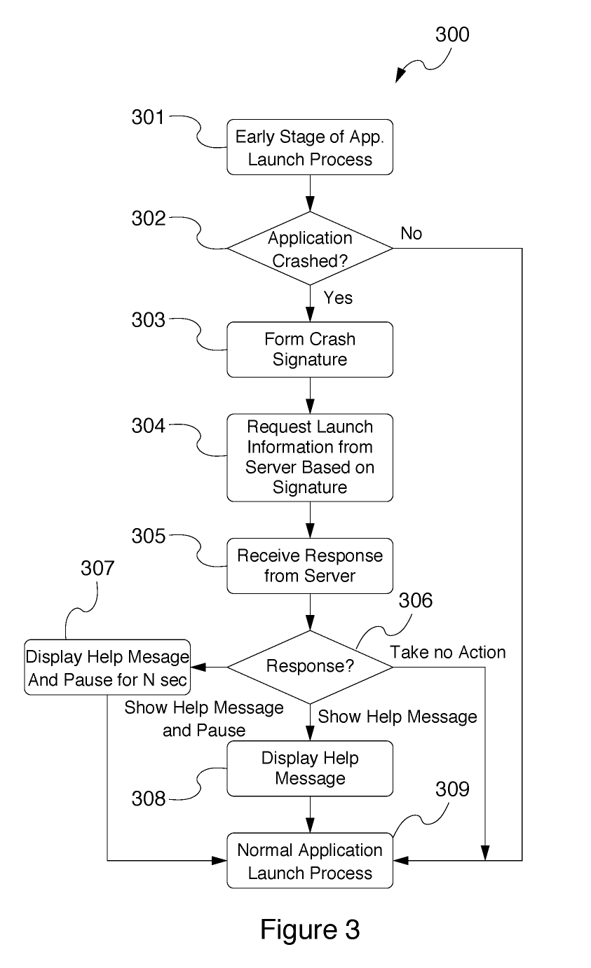

FIG. 3 illustrates an exemplary operating sequence 300 of an embodiment of a distributed computerized system 100 for assisting the user in properly handling the software application crash. The process 300 starts at an early stage of application launch process 301, whereupon the normal launch of the application 102 is suspended and the crash assistant application 103 is invoked. As would be appreciated by persons of ordinary skill in the art, the crash assistant functionality described herein must be performed before any of the substantive functionality of the application 102 itself is executed. If the client side crash assistant application 103 is invoked too late, there is a chance that the application 102 may crash before the invocation of the client side crash assistant application 103, which will result in its inability to assists the user in remedying the application crash.

In one or more embodiments, at step 302, the client side crash assistant application 103 determines whether the application 102 crashed during its previous launch based on the information provided by the crash handling library 104. As stated above, the information provided by the crash handling library 104 may include stack trace of the application crash, if the latter has occurred. If it is determined that the application has not crashed, the normal application launch is resumed, see step 309. On the other hand, if the application has previously crashed, the control is passed to step 303, whereupon the crash signature is formed.

In one or more embodiments, the crash signature is formed based on the stack trace received from the crash handling library 104. As would be appreciated by persons of ordinary skill in the art, similar application crashes will have identical or substantially identical stack traces. Thus, using relative function addresses from the stack trace of crashed thread the client side crash assistant application 103 is able to form the crash signature. In one or more embodiments, to compute the application crash signature, the crash assistant application 103 may use a hashing algorithm, such as MD5, well known to persons or ordinary skill in the art, applied to the concatenation of the crash addresses. However, as would be understood by persons of ordinary skill in the art, the invention is not limited to the described exemplary method for computing a crash signature and any other suitable method or algorithm, including a variety of now known or later developed hashing algorithms, may be used for this purpose without departing from the scope and spirit of the invention. The computed crash signature is subsequently used by the server side crash assistant application 108 to retrieve and provide the proper remedial action information to the client side crash assistant application 103.

In one or more embodiments, at step 304, a request is sent to the server 105 executing the server side crash assistant application 108 for the crash remedial action information based on the computed signature. In one or more embodiments, the client side crash assistant application 103 sends the crashed application version, the operating system (OS) version and the computed crash signature to the server 105 executing the server side crash assistant application 108. The received information is used by the server side crash assistant application 108 to retrieve from the database 109 the proper remedial action information tailored for the particular application and the crash conditions. In one or more embodiments, the database 109 may include a database table storing key-value pairs where the key is the combination of the crash signature and the application version and the value is the crash remedial action information.

In one or more embodiments, at step 305, the server side crash assistant application 108 responds with the specific crash remedial action information, which is received by the client side crash assistant application 103. The server response is analyzed at step 306. In one exemplary embodiment, the server may instruct the client side crash assistant application 103 to display a help message to the user and pause the launch of the application for a predetermined amount of time, see step 307. As would be understood, if the application persistently crashes on the start, it is important to guarantee that the user will see the informational message for at least N seconds before the next crash takes place. In one exemplary embodiment, to prevent application from crashing, no application code is run until the client side crash assistant application 103 finishes its work. Alternatively, the instruction received from the server may require displaying of a message to the user without pausing the application launch, see step 308. Finally, the sever may instruct the client side crash assistant application 103 to take no action.

Subsequently, at step 309, the execution of the client side crash assistant application 103 terminates and the normal launch process of the application 102 is resumed. It should be noted that the server side crash assistant application 108 may instruct the client side crash assistant application 103 to perform a variety of other actions, such as change configuration parameters of the application 102 or change permission settings of the operating system executed by the client computer system 101. As would be appreciated by persons of skill in the art, additional messages may be displayed to the user requesting user's permissions to make the requested configuration or permissions changes. Thus, it should be understood that the described specific examples of remedial actions are exemplary only and they should not be interpreted in the limiting sense.

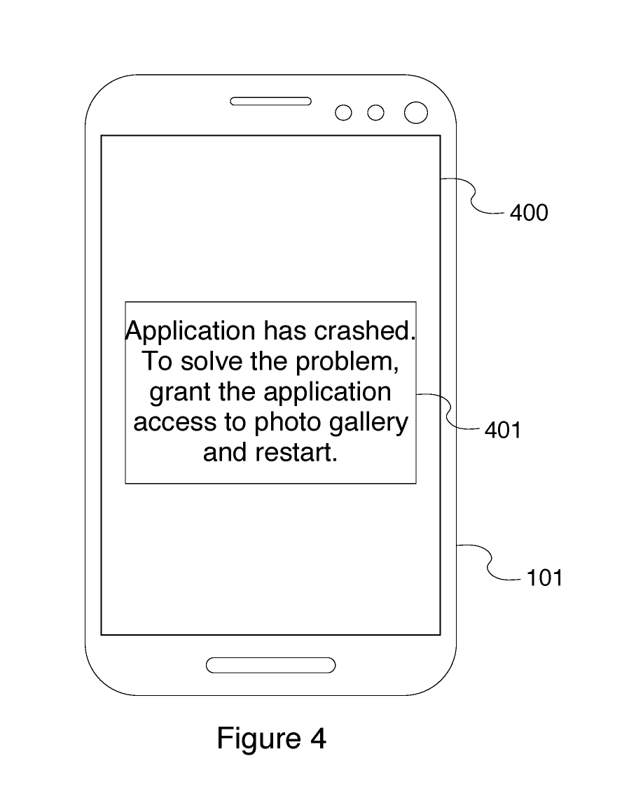

FIG. 4 illustrates an exemplary user interface 400 of a client portion of the distributed computerized system for assisting the user in remedying the software application crash. The user interface 400 is generated on the screen of the client computer system 101 in response to the application crash at steps 308 or 309 of the operating sequence 300 illustrated in FIG. 3 and may include displaying the remedial action information received from the server side crash assistant application 108. In the example shown in FIG. 4, the user interface 400 displays the following exemplary remedial message 401 to the user: “Application has crashed. To solve the problem, grant the application access to photo gallery and restart.”

An exemplary use scenario of the embodiment of a distributed computerized system 100 for assisting the user in remedying the software application crash will now be described. First, the application 102 run by the user crashes on startup. The stack trace from the crash is extracted and saved in the crash handling library 104, which will indicate that the application crash has occurred. During the next application start, the execution of the application code is suspended to prevent executing the faulty application code that has previously lead to the application crash and the crash information (e.g. crash stack trace) is retrieved from the crash handling library 104. After that, crash signature is generated from the crash stack trace using, for example MD5 hashing algorithm, and sent to the server. In response, the server sends remedial action instructing the following exemplary message to be displayed to the user: “Application has crashed. To solve the problem, grant the application access to photo gallery and restart,” while pausing the loading of the application. The user reads the displayed message, changes the application access permissions and re-launches the application which now executes correctly.

It should be noted that storing the crash signatures and the respective remedial action information in the database 109 deployed on the server side 105 allows flexible and easy updating of the crash remedial action information, conveniently adding new crash signatures and the corresponding remedial measures once the new causes of the crashes are discovered, adding new messages to application users, blocking the execution of the application altogether, and/or easily performing any other changes or updates. Also, while the client computer system 101 is described herein as a mobile device, the invention is not so limited and any other suitable computerized system, such as a desktop or notebook computer, may perform the functions of the client computer system 101 in executing the application 102, the crash assistant application 103 and hosting the crash handling library 104.

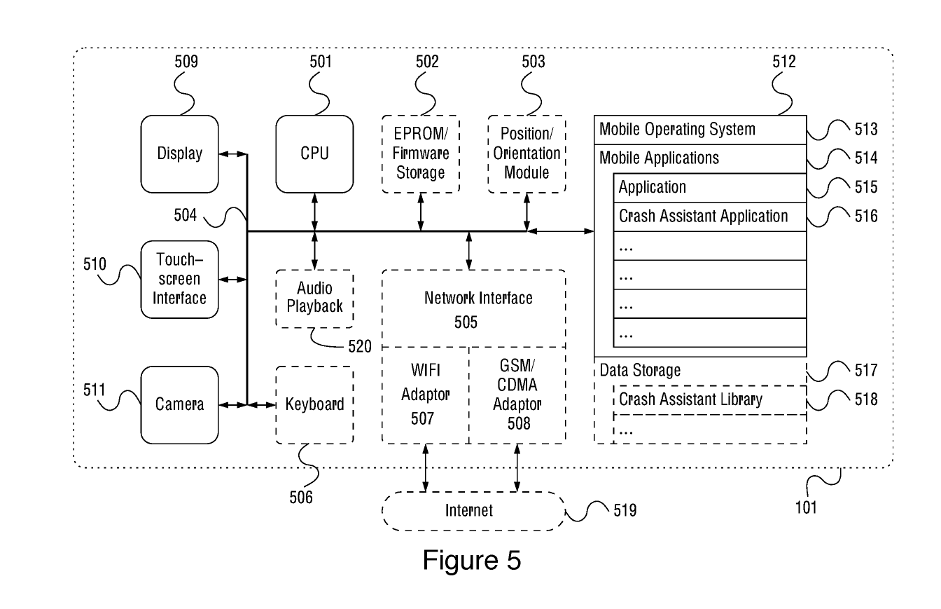

FIG. 5 is a block diagram that illustrates an exemplary embodiment of the computerized client system 101 representing the client portion of the distributed computerized system 100 for assisting the user in remedying the software application crash. In one or more embodiments, the computerized client system 101 (also referred to herein as “computerized system 101” or “client computer system 101”) may be implemented within the form factor of a mobile computing device, such as a smartphone, a personal digital assistant (PDA), or a tablet computer, all of which are available commercially and are well known to persons of skill in the art. In an alternative embodiment, the computerized system 101 may be implemented based on a desktop, a laptop or a notebook computer. Yet in an alternative embodiment, the computerized system 101 may be an embedded system, incorporated into an electronic device with certain specialized functions, such as an electronic book (or e-book) reader. Yet in an alternative embodiment, the computerized system 101 may be implemented as a part of an augmented reality head-mounted display (HMD) systems, also well known to persons of ordinary skill in the art.

The computerized system 101 may include a data bus 504 or other interconnect or communication mechanism for communicating information across and among various hardware components of the computerized system 101, and a central processing unit (CPU or simply processor) 501 coupled with the data bus 504 for processing information and performing other computational and control tasks. Computerized system 101 also includes a memory 512, such as a random access memory (RAM) or other dynamic storage device, coupled to the data bus 504 for storing various information as well as instructions to be executed by the processor 501. The memory 512 may also include persistent storage devices, such as a magnetic disk, optical disk, solid-state flash memory device or other non-volatile solid-state storage devices.

In one or more embodiments, the memory 512 may also be used for storing temporary variables or other intermediate information during execution of instructions by the processor 501. Optionally, computerized system 101 may further include a read only memory (ROM or EPROM) 502 or other static storage device coupled to the data bus 504 for storing static information and instructions for the processor 501, such as firmware necessary for the operation of the computerized system 101, basic input-output system (BIOS), as well as various configuration parameters of the computerized system 101.

In one or more embodiments, the computerized system 101 may incorporate a display device 509, which may be also coupled to the data bus 504, for displaying various information to a user of the computerized system 101. In an alternative embodiment, the display 509 may be associated with a graphics controller and/or graphics processor (not shown). The display device 509 may be implemented as a liquid crystal display (LCD), manufactured, for example, using a thin-film transistor (TFT) technology or an organic light emitting diode (OLED) technology, both of which are well known to persons of ordinary skill in the art. In various embodiments, the display device 509 may be incorporated into the same general enclosure with the remaining components of the computerized system 101. In an alternative embodiment, the display device 509 may be positioned outside of such enclosure.

In one or more embodiments, the display device 509 may be implemented in a form of a projector or a mini-projector configured to project information on various objects, such as glasses worn by the user. In one or more embodiments, the display device 509 may be configured to be mountable on the head of the user. To this end, the display device 509 may be provided with suitable mounting hardware (not shown).

In one or more embodiments, the computerized system 101 may further incorporate an audio playback device 520 connected to the data bus 504 and configured to play various audio files, such as MPEG-3 files, or audio tracks of various video files, such as MPEG-4 files, well known to persons of ordinary skill in the art. To this end, the computerized system 101 may also incorporate waive or sound processor or a similar device (not shown).

In one or more embodiments, the computerized system 101 may incorporate one or more input devices, such as a touchscreen interface 510 for receiving user's tactile commands, a camera 511 for acquiring still images and video of various objects, as well as a keyboard 506, which all may be coupled to the data bus 504 for communicating information, including, without limitation, images and video, as well as user command selections to the processor 501. In an alternative embodiment, input devices may include a system for tracking eye movements of the user (not shown), which may be used to indicate to the computerized system 101 the command selection made by the user.

In one or more embodiments, the computerized system 101 may additionally include a positioning and orientation module 503 configured to supply data on the current geographical position, spatial orientation as well as acceleration of the computerized system 101 to the processor 501 via the data bus 504. The geographical position information may be obtained by the positioning module 503 using, for example, global positioning system (GPS) technology and/or other positioning techniques such as by using information provided by proximate cell towers and/or WIFI hotspots. The acceleration data is supplied by one or more accelerometers incorporated into the positioning and orientation module 503. Finally, the orientation information may be obtained using acceleration measurements in all 3 axes, including the gravity. In one or more embodiments, the position, orientation and acceleration metadata provided by the positioning and orientation module 503 is continuously recorded and stored in the data storage unit 517.

In one or more embodiments, the computerized system 101 may additionally include a communication interface, such as a network interface 505 coupled to the data bus 504. The network interface 505 may be configured to establish a connection between the computerized system 101 and the Internet 519 using at least one of WIFI interface 507 and the cellular network (GSM or CDMA) adaptor 508. The network interface 505 may be configured to provide a two-way data communication between the computerized system 101 and the Internet 519. The WIFI interface 507 may operate in compliance with 802.11a, 802.11b, 802.11g and/or 802.11n protocols as well as Bluetooth protocol well known to persons of ordinary skill in the art. In an exemplary implementation, the WIFI interface 507 and the cellular network (GSM or CDMA) adaptor 508 send and receive electrical or electromagnetic signals that carry digital data streams representing various types of information.

In one or more embodiments, the Internet 519 typically provides data communication through one or more sub-networks to other network resources. Thus, the computerized system 101 is capable of accessing a variety of network resources located anywhere on the Internet 519, such as remote media servers, web servers, other content servers as well as other network data storage resources. In one or more embodiments, the computerized system 101 is configured send and receive messages, media and other data, including application program code, through a variety of network(s) including Internet 519 by means of the network interface 505. In the Internet example, when the computerized system 101 acts as a network client, it may request code or data for an application program executing on the computerized system 101. Similarly, it may send various data or computer code to other network resources.

In one or more embodiments, the functionality described herein is implemented by computerized system 101 in response to processor 501 executing one or more sequences of one or more instructions contained in the memory 512. Such instructions may be read into the memory 512 from another computer-readable medium. Execution of the sequences of instructions contained in the memory 512 causes the processor 501 to perform the various process steps described herein. In alternative embodiments, hard-wired circuitry may be used in place of or in combination with software instructions to implement the embodiments invention. Thus, embodiments of the invention are not limited to any specific combination of hardware circuitry and software.

The term “computer-readable medium” as used herein refers to any medium that participates in providing instructions to processor 501 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to processor 501 for execution. For example, the instructions may initially be carried on a magnetic disk from a remote computer. Alternatively, a remote computer can load the instructions into its dynamic memory and send the instructions over the Internet 519. Specifically, the computer instructions may be downloaded into the memory 512 of the computerized system 101 from the foresaid remote computer via the Internet 519 using a variety of network data communication protocols well known in the art.

In one or more embodiments, the memory 512 of the computerized system 101 may store any of the following software programs, applications or modules:

1. Operating system (OS) 513, which may be a mobile operating system for implementing basic system services and managing various hardware components of the computerized system 101. Exemplary embodiments of the operating system 513 are well known to persons of skill in the art, and may include any now known or later developed operating systems, such as Microsoft Windows, Unix, Mac OS, Linux, FreeBSD, iOS, Android, Microsoft Windows Mobile and the like.

2. Applications 514, which may be mobile applications, may include, for example, a set of software applications executed by the processor 501 of the computerized system 101, which cause the computerized system 101 to perform certain predetermined functions, such as acquire digital images using the camera 511 or play media files using the display 509 and/or an audio playback device 520. In one or more embodiments, the applications 514 may include the application 515 and the crash assistant application 516 for remedying the crash of the application 515.

3. Data storage 517 may be used, for example, for storing the crash assistant library 518.

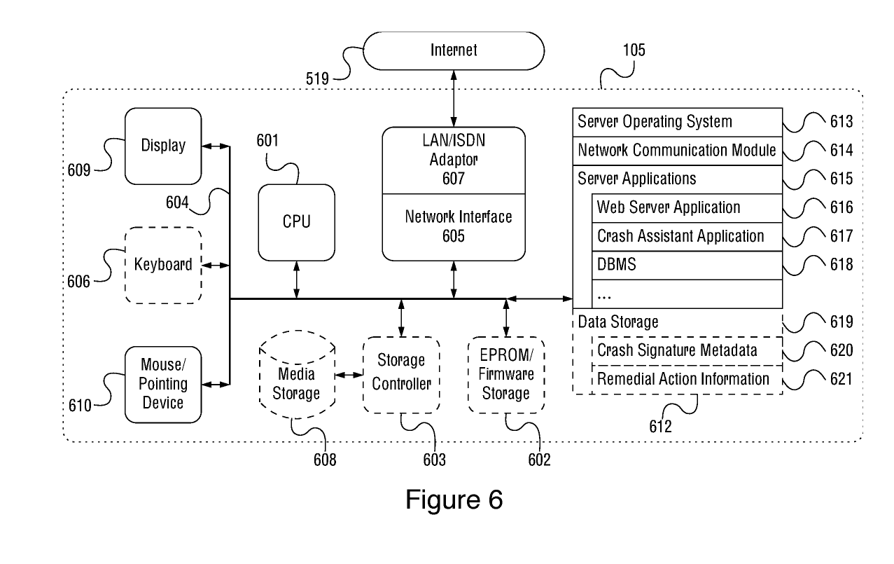

FIG. 6 is a block diagram that illustrates an exemplary embodiment of the computerized server system 105 (also referred to herein as “server computer system 105”) representing server portion of the distributed computerized system 100 for assisting the user in remedying the software application crash.

In one or more embodiments, the computerized server system 105 may incorporate a data bus 604, which may be substantially similar and may perform substantially similar functions as the data bus 504 of the computerized system 101 illustrated in FIG. 5. In various embodiments, the data bus 604 may use the same or different interconnect and/or communication protocol as the data bus 504. The one or more processors (CPUs) 601, the network interface 605, the EPROM/Firmware storage 602, the display 609 and the keyboard 606 of the computerized server system 105 may be likewise substantially similar to the respective processor 501, the network interface 505, the EPROM/Firmware storage 502, the display 509 and the keyboard 506 of the computerized system 101, except that the former components are deployed in a server platform configuration. In various implementations, the one or more processor 601 may have substantially increased processing power as compared with the processor 501.

In addition to the input device 606 (keyboard), the computerized server system 105 may additionally include a cursor control device 610, such as a mouse, a trackball, or cursor direction keys for communicating direction information and command selections to processor 601 and for controlling cursor movement on the display 609. This input device typically has two degrees of freedom in two axes, a first axis (e.g., x) and a second axis (e.g., y), that allows the device to specify positions in a plane.

The LAN/ISDN adaptor 607 of the computerized server system 105 may be implemented, for example, using an integrated services digital network (ISDN) card or a modem to provide a data communication connection to a corresponding type of telephone line, which is interfaced with the Internet 519 using Internet service provider's hardware (not shown). As another example, the LAN/ISDN adaptor 607 may be a local area network interface card (LAN NIC) to provide a data communication connection to a compatible LAN and the Internet 519. To store various media files, the computerized server system 105 may be provided with a media storage 608 connected to the data bus 604 by means of a storage controller 603.

In one or more embodiments, the memory 612 of the computerized server system 105 may store any of the following software programs, applications or modules:

1. Server operating system (OS) 613, which may be an operating system for implementing basic system services and managing various hardware components of the computerized server system 105. Exemplary embodiments of the server operating system 613 include, without limitation, Linux, Unix, Windows Server, FreeBSD, NetBSD, Mac OSX Server, HP-UX, AIX and Solaris, which are all well known to persons of skill in the art, as well as any other now known or later developed operating system.

2. Network communication module 614 may incorporate, for example, one or more network protocol stacks which are used to establish a networking connection between the computerized server system 105 and the various network entities of the Internet 519, such as the computerized client system 101, using the network interface 605 working in conjunction with the LAN/ISDN adaptor 607.

3. Server applications 615 may include, for example, a set of software applications executed by one or more processors 601 of the computerized server system 105, which cause the computerized server system 105 to perform certain predetermined functions or tasks. In one or more embodiments, the server applications 615 may include a web server application 616, a crash assistant application 617 and a database management system (DBMS) 618 comprising a set of software programs enabling storage, modification, and extraction of various data from the database 109 shown in FIG. 1. The database management system 618 may be implemented based on any now known or later developed type of database software, such as a relational database management system, including, without limitation, MySQL, Oracle, SQL Server, DB2, SQL Anywhere, PostgreSQL, SQLite, Firebird and/or MaxDB, which are well-known to persons of skill in the art. In an alternative embodiment, a cloud-based distributed database, such as Amazon Relational Database Service (Amazon RDS), well known to persons of ordinary skill in the art, may also be used to implement the database management system 616. In one or more embodiments, the aforesaid web server application 616 may be of any known of later developed type, including, without limitation, Apache, Microsoft IIS, nginx, Google GWS, lighttpd and Sun Microsystems SunOne.

4. Data storage 619 may be used, for example, for storing database tables managed by the database management system 618. The information stored in the aforesaid database tables may include the crash signature metadata 620 and remedial action information 621.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the computerized systems and methods for assisting users in handling of software application crashes. It is intended that the specification and examples be considered as exemplary only, with a true scope and spirit of the invention being indicated by the following claims.

What is claimed is:

1. A computer-implemented method for handling a crash of an application, the computer-implemented method being performed in connection with a distributed computer system comprising a client computer system directly accessible by a user and a server computer system, the client computer system comprising a central processing unit and a memory, the computer-implemented method comprising:
a. upon occurrence of the crash of the application on the client computer system, locally storing an application crash information in the memory; and
b. upon a subsequent launch of the application:
i. suspending execution of at least a portion of a code of the application;
ii. retrieving from the memory the stored application crash information;
iii. generating, using the central processing unit, a signature of the crash of the application based on the retrieved application crash information;
iv. sending the generated signature of the crash of the application to the server computer system;
v. receiving remedial action information from the server computer system; and
vi. performing a remedial action in connection with the application based on the received remedial action information.

2. The computer-implemented method of claim 1, further comprising resuming a normal launch of the application.

3. The computer-implemented method of claim 1, wherein the application crash information is stored in a library.

4. The computer-implemented method of claim 1, wherein the application crash information comprises a stack trace associated with the crash of the application.

5. The computer-implemented method of claim 4, wherein the stack trace comprises a plurality of relative addresses of functions executed before the crash of the application and wherein the signature of the crash of the application is generated by hashing a concatenation of the plurality the relative addresses.

6. The computer-implemented method of claim 1, wherein the received remedial action information comprises a message for displaying to the user and wherein performing the remedial action comprises displaying the message to the user.

7. The computer-implemented method of claim 6, wherein the received remedial action information further comprises an instruction to suspend the execution of the application and wherein performing the remedial action further comprises suspending the execution of the application.

8. The computer-implemented method of claim 1, wherein the received remedial action information comprises an instruction to change configuration parameters of the application and wherein performing the remedial action comprises changing the configuration parameters of the application.

9. The computer-implemented method of claim 1, wherein the received remedial action information comprises an instruction to change access permissions of the application and wherein performing the remedial action comprises changing the access permissions of the application.

10. A non-transitory computer-readable medium embodying a set of computer-readable instructions, which, when executed in connection with a distributed computer system comprising a client computer system directly accessible by a user and a server computer system, the client computer system comprising a central processing unit and a memory, cause the client computer system to perform a computer-implemented method for handling a crash of an application, the computer-implemented method comprising:
a. upon occurrence of the crash of the application on the client computer system, locally storing an application crash information in the memory; and
b. upon a subsequent launch of the application:
i. suspending execution of at least a portion of a code of the application;
ii. retrieving from the memory the stored application crash information;
iii. generating, using the central processing unit, a signature of the crash of the application based on the retrieved application crash information;
iv. sending the generated signature of the crash of the application to the server computer system;
v. receiving remedial action information from the server computer system; and
vi. performing a remedial action in connection with the application based on the received remedial action information.

11. The non-transitory computer-readable medium of claim 10, wherein the computer-implemented method further comprises resuming a normal launch of the application.

12. The non-transitory computer-readable medium of claim 10, wherein the application crash information is stored in a library.

13. The non-transitory computer-readable medium of claim 10, wherein the application crash information comprises a stack trace associated with the crash of the application.

14. The non-transitory computer-readable medium of claim 13, wherein the stack trace comprises a plurality of relative addresses of functions executed before the crash of the application and wherein the signature of the crash of the application is generated by hashing a concatenation of the plurality the relative addresses.

15. The non-transitory computer-readable medium of claim 10, wherein the received remedial action information comprises a message for displaying to the user and wherein performing the remedial action comprises displaying the message to the user.

16. The non-transitory computer-readable medium of claim 15, wherein the received remedial action information further comprises an instruction to suspend the execution of the application and wherein performing the remedial action further comprises suspending the execution of the application.

17. The non-transitory computer-readable medium of claim 10, wherein the received remedial action information comprises an instruction to change configuration parameters of the application and wherein performing the remedial action comprises changing the configuration parameters of the application.

18. The non-transitory computer-readable medium of claim 10, wherein the received remedial action information comprises an instruction to change access permissions of the application and wherein performing the remedial action comprises changing the access permissions of the application.

19. A client computer system directly accessible by a user, the client computer system comprising a central processing unit and a memory storing a set of instructions executable by the central processing unit, the set of instructions comprising instructions for:
a. upon occurrence of a crash of an application on the client computer system, locally storing an application crash information in the memory; and
b. upon a subsequent launch of the application:
i. suspending execution of at least a portion of a code of the application;
ii. retrieving from the memory the stored application crash information;
iii. generating, using the central processing unit, a signature of the crash of the application based on the retrieved application crash information;
iv. sending the generated signature of the crash of the application to a server computer system;
v. receiving remedial action information from the server computer system; and
vi. performing a remedial action in connection with the application based on the received remedial action information.

20. The client computer system of claim 19, wherein the application crash information comprises a stack trace associated with the crash of the application.
